(19) United States
(12) Patent Application Publication
(10) Pub. No.: US 2019/0053324 A1
(43) Pub. Date: Feb. 14, 2019

(54) UE Autonomous Release for Internet of Things

(71) Applicant: MEDIATEK INC., Hsinchu (TW)

(72) Inventors: Li-Chuan Tseng, Hsinchu (TW); Per Johan Mikael Johansson, Vikarbyn (SE); Gilles Charbit, Cambridge (GB)

(21) Appl. No.: 16/100,980

(22) Filed: Aug. 10, 2018

Related U.S. Application Data
(60) Provisional application No. 62/544,094, filed on Aug. 11, 2017.

(51) Int. Cl. H04W 76/30

(52) U.S. Cl. CPC H04W 76/30

(57) ABSTRACT

A method of user equipment (UE) autonomous release RRC connection to reduce power consumption and signaling overhead is proposed. UEs sending small amount of data with long period, e.g., Machine-Type Communication (MTC) and Narrow-Band Internet of Things (NB-IoT) UEs, are allowed to be released autonomously after sending a given amount of data with corresponding request and configuration procedures. In one embodiment, UE sends an RRC connection request with UE autonomous release request, and receives an RRC setup message with UE autonomous release information. UE then transmits an RRC setup complete message with piggybacked uplink data. UE autonomously releases to Idle state upon expiry of an inactivity timer.

### CROSS REFERENCE TO RELATED APPLICATION

This application claims priority under 35 U.S.C. § 119 from U.S. Provisional Application No. 62/544,094, entitled “UE Autonomous Release for Internet of Things,” filed on Aug. 11, 2017, the subject matter of which is incorporated herein by reference.

### TECHNICAL FIELD

The disclosed embodiments relate generally to wireless communication systems, and, more particularly, to machine-type user equipments (UEs) with autonomous connection release.

### BACKGROUND

3GPP Long-Term Evolution (LTE) systems offer high peak data rates, low latency, improved system capacity, and low operating cost resulting from simple network architecture. A 3GPP LTE system also provides seamless integration to older wireless network, such as GSM, CDMA and Universal Mobile Telecommunication System (UMTS). Enhancements to LTE systems are considered so that they can meet or exceed IMA-Advanced fourth generation (4G) standard. One of the key enhancements is to support bandwidth up to 100 MHz and be backwards compatible with the existing wireless network system. In LTE/LTE-A systems, an evolved universal terrestrial radio access network (E-UTRAN) includes a plurality of evolved Node-Bs (eNBs) communicating with a plurality of mobile stations, referred as user equipments (UEs).

Typically, each UE needs to periodically measure the received signal quality of the serving cell and neighbor cells and reports the measurement result to its serving eNB for potential handover or cell reselection. The measurements may drain the UE battery power. In order to keep UE battery consumption low, the UE needs to toggle between sleeping and awake states. Preferably it should be possible for UEs in RRC Connected mode to apply similar sleep/awake performance as in RRC Idle mode, to have similar battery consumption. To save power, Discontinuous Reception (DRX) needs to be used in Connected mode, with short awake times and long sleep cycles. With DRX extension, UEs can be configured with even longer RRC Connected mode DRX cycle.

UE state transition between Connected and Idle modes introduces signaling overhead. To reduce such overhead, UE is kept in Connected mode (i.e. Active) for a given duration before being released via RRC connection release command. However, UE consumes more power in Connected mode even without data transmission, since the DRX cycle in Connected mode is shorter. A problem of prior art is that the UE, after the last data transmission, must wait for the RRC connection release command to send it to Idle mode. If the amount of data is small, such mechanism not only introduce signaling overhead, but also consumes power when UE is kept in Connected mode waiting for the RRC connection release command.

For some UEs (e.g., machine type communication (MTC) and narrowband Internet of Things (NB-IoT) devices) that transmits only a small amount of data in each connection, such overhead needs to be avoided. If UE can be released quicker after last data transmission, it can enter RRC Idle or Inactive mode and apply a much longer DRX cycle and reduce power consumption. Moreover, if the RRC connection release can be done autonomously by UE without RRC connection release command, signaling overhead can be further reduced.

### SUMMARY

A method of user equipment (UE) autonomous release RRC connection to reduce power consumption and signaling overhead is proposed. UEs sending small amount of data with long period, e.g., Machine-Type Communication (MTC) and Narrow-Band Internet of Things (NB-IoT) UEs, are allowed to be released autonomously after sending a given amount of data with corresponding request and configuration procedures.

In one embodiment, a UE transmits a radio resource control (RRC) connection request message to a base station to establish an RRC connection in a wireless communication network. The UE receives an RRC connection setup message from the base station, and the RRC setup message comprises UE autonomous release information. The UE transmits an RRC connection setup complete message to the base station together with piggybacked uplink data. The UE starts an inactivity timer upon completion of data transmission or reception. The UE autonomously releases the RRC connection based on the RRC release information upon expiry of the inactivity timer maintained by the UE.

In another embodiment, a base station receiving a radio resource control (RRC) connection request message from a user equipment (UE) to establish an RRC connection in a wireless communication network. The BS transmits an RRC connection setup message, and the RRC setup message comprises UE autonomous release information upon obtaining a UE autonomous release request. The BS receives an RRC connection setup complete message together with piggybacked uplink data. The BS starts an inactivity timer for UE autonomous release upon completion of UE data transmission or reception. The BS determines whether the UE is in RRC Idle state based on the RRC release information upon expiry of the inactivity timer.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an RRC connection setup and release procedure of a user equipment (UE) with UE autonomous release in a 4G/5G network in accordance with one novel aspect.

FIG. 2 is a simplified block diagram of a UE for autonomous release of RRC connection in accordance with one novel aspect.

FIG. 3 illustrates a first embodiment of a message flow of RRC connection setup and release supporting UE autonomous release.

FIG. 4 illustrates a second embodiment of a message flow of RRC connection setup and release supporting UE autonomous release.

FIG. 5 illustrates a first embodiment of inactivity timer in DRX operation with UE auto release in accordance with one novel aspect.

FIG. 6 illustrates a second embodiment of inactivity timer in DRX operation with UE auto release in accordance with one novel aspect.

FIG. 7 is a flow chart of a method of UE autonomous release from UE perspective in a wireless communication network.

FIG. 8 is a flow chart of a method of UE autonomous release from network perspective in a wireless communication network.

### DETAILED DESCRIPTION

Reference will now be made in detail to some embodiments of the invention, examples of which are illustrated in the accompanying drawings.

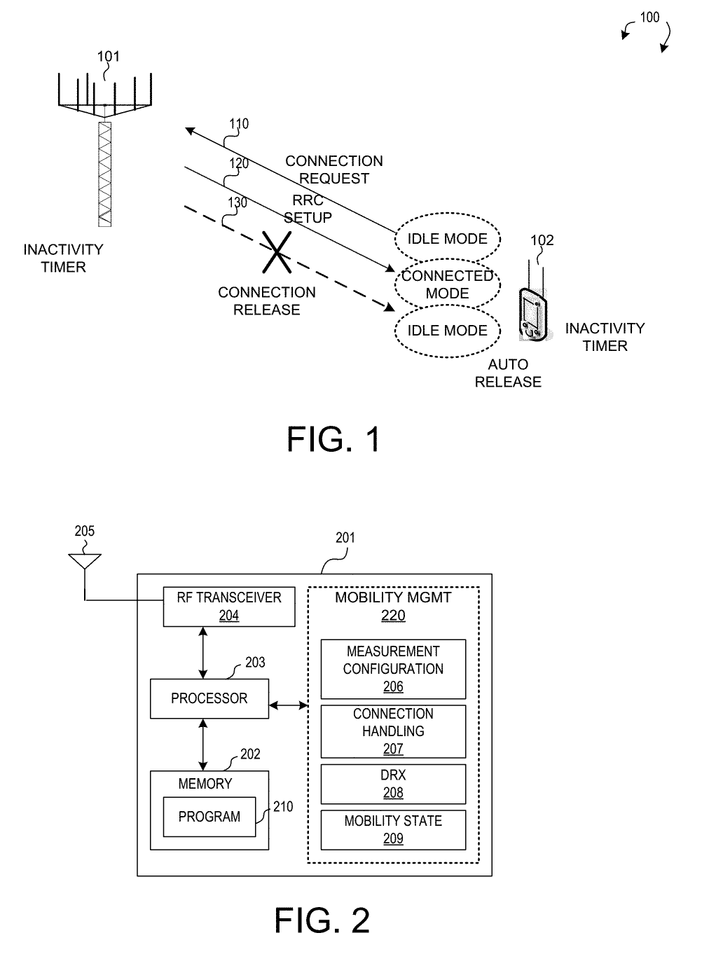

FIG. 1 illustrates a radio resource control (RRC) connection setup and release procedure of a user equipment (UE) with UE autonomous release in a 4G/5G network 100 in accordance with one novel aspect. In LTE/LTE-A systems, an evolved universal terrestrial radio access network (E-UTRAN) includes a plurality of base stations, referred as evolved Node-Bs (eNBs) (e.g., BS 101) communicating with a plurality of mobile stations, referred as user equipments (UEs) (e.g., UE 102). In next generation 5G systems, base station is referred to as gNB. Both eNB and gNB are referred to as base station (BS).

Typically, each UE needs to periodically measure the received signal quality of the serving cell and neighbor cells and reports the measurement result to its serving BS for potential cell reselection and handover. The measurements may drain the UE battery power. To save power, Discontinuous Reception (DRX) can be used both in RRC Idle mode and in RRC Connected mode. Initially, UE 102 camps on a cell and stays in RRC Idle mode. For data transmission, UE 102 needs to establish an RRC connection with BS 101 and enter in RRC Connected mode. The state transition between RRC Connected and RRC Idle modes introduces signaling overhead. To reduce such overhead, UE can be kept in Connected (i.e. Active) for a given duration before being released to Idle (i.e., Inactive) via RRC Release command. However, UE consumes more power in Connected mode even without data transmission, since the DRX cycle in Connected mode is shorter.

A problem of prior art is that the UE, after the last data transmission, must wait for the RRC connection release message to go back to Idle mode. If the amount of data is small, such mechanism not only introduces signaling overhead, but also consumes power when UE is kept in Connected mode waiting for the RRC connection release message. In accordance with one novel aspect, for some machine-type (e.g., MTC, NB-IoT) UEs that transmits only a small amount of data in each connection, such overhead can be avoided. If UE can be released quicker after last data transmission, it can enter RRC Idle or Inactive mode and apply a much longer DRX cycle and reduce power consumption. Moreover, if the RRC release can be done autonomously without RRC Release command, signaling overhead can be further reduced.

In the example of FIG. 1, a novel UE autonomous release method is proposed to reduce the power consumption and signaling overhead for MTC and NB-IoT UEs sending small amount of data with long period. Specifically, if UE sends only a given small amount of data, it is allowed to be autonomously released after data transmission completes, without being explicitly commanded by network via RRC release message 130. To enable UE autonomous release in the context of MTC and other NB-IoT communication systems, UE 102 sends an autonomous release request via RRC connection request 110, BS 101 sends RRC setup message 120 carrying necessary information for UE autonomous release, and inactivity timer operations at both UE and network sides are coordinated between them to facilitate the UE autonomous release mechanism.

The notation “connection request” is here intended to include embodiments where a UE in Idle mode request for a connection for its mobile-originated data or reception of a paging message. It may also be generalized to mean a “resume request” where a UE in Inactive mode requesting to resume the previously suspended connection. The notation of “RRC Connection setup” or just “RRC setup” is used here to denote the procedure that the network sends the UE to Connected mode from Idle or Inactive mode. Moreover, for UEs transmitting only a small amount of data, the RRC setup procedure may also indicate UE to perform autonomous release under certain conditions, e.g., complete transmission of a given amount of data, or upon sending release assistance indication. The notation of “inactivity timer” is used to denote a timer which is started after data transmission complete, and upon its expiry the UE is considered to enter Idle mode or Inactive mode. Inactivity timers are maintained at both network and UE sides, respectively. In this document, “release to Idle” also includes cases when the UE transits to RRC Inactive mode or RRC light connected mode, i.e. any case when the UE transits to a state where UE-based mobility is used, e.g. cell reselection.

FIG. 2 is a simplified block diagram of a UE for mobility management with power consumption enhancements in accordance with one novel aspect. UE 201 has memory 202, a processor 203, and radio frequency (RF) transceiver module 206. RF transceiver 204 is coupled with antenna 205, receives RF signals from antenna 207, converts them to baseband signals, and sends them to processor 203. RF transceiver 204 also converts received baseband signals from the processor 203, converts them to RF signals, and sends out to antenna 205. Processor 203 processes the received baseband signals and invokes different functional modules to perform features in UE 201. Memory 202 stores data and program instructions 210 to be executed by the processor to control the operations of UE 201. Suitable processors include, by way of example, a special purpose processor, a digital signal processor (DSP), a plurality of microprocessors, one or more microprocessors associated with a DSP core, a controller, a microcontroller, Application specific integrated circuits (ASICs), Field programmable gate array (FPGAs) circuits, and other type of integrated circuit (IC), and/or state machine. A processor in associated with software may be used to implement and configure features of UE 201.

UE 201 also includes multiple function modules and circuits that carry out different tasks in accordance with embodiments of the current invention. The function modules and circuits may be implemented and configured by hardware, firmware, software, and combinations of the above. In one example, mobility management module 220 further comprises several functional modules and circuits. Measurement configuration module 206 that receives measurement and reporting configuration from the network and configures its measurement interval and reporting criteria accordingly. Connection handling circuit 207 that performs cell selection or reselection, connection establishment or reselection, and handover procedures such that UE camps on or connects to a serving cell. Discontinuous Reception (DRX) module 208 configures UE 201 for DRX operation with corresponding DRX parameters received from the network. Mobility state module 209 determines UE mobility states by configuration or self-estimation such that UE 201 can operate in corresponding operation modes for power consumption enhancements.

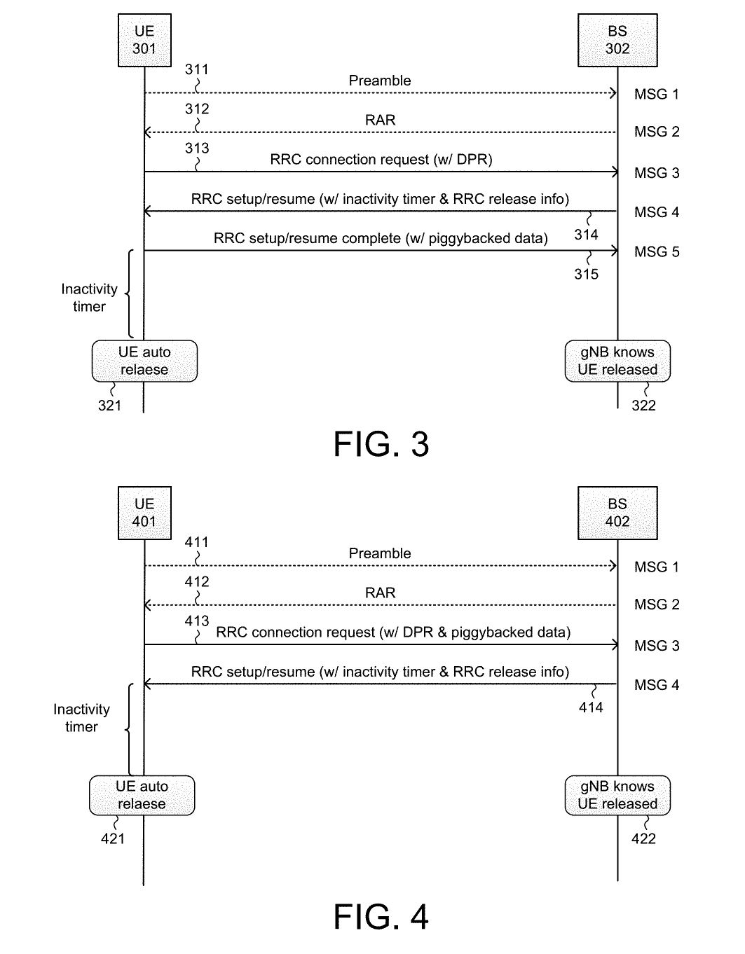

FIG. 3 illustrates a first embodiment of a message flow of RRC connection setup and release supporting UE autonomous release in accordance with one novel aspect. In step 311, UE 301 transmits a preamble over a random-access channel (RACH) to BS 302 to start a RACH procedure (MSG1). In step 312, UE 301 receives a random-access response (RAR) from BS 302 (MSG2). The RACH procedure is typically initiated when UE 301 has uplink data to be transmitted to the network. If UE 301 is an MTC or NB-IoT device, the amount of uplink data to be transmitted may be very small. If UE 301 knows it is sending only one piece of uplink data, UE 301 can tell the network that it wants to enter Idle or Inactive state after the uplink data transmission completes. This can be done by introducing an indication bit in RRC connection setup or resume request message (MSG3), requesting UE autonomous release after the amount of data indicated in Data Volume and Power Headroom Report (DPR) has been delivered. Accordingly, in step 313, UE 301 sends an RRC connection setup or resume request message to BS 302 (MSG3). The connection request or resume request comprises a UE autonomous release request and DPR, requesting UE autonomous release after the amount of data indicated by DPR has been delivered.

In step 314, BS 302 sends an RRC connection setup or resume response back to UE 301 (MSG4), which comprises RRC release information and an inactivity timer value. In the current system, the network detects UE inactivity via an inactivity timer maintained by the network, and UE is sent to Idle or Inactive state via RRC connection release message when the inactivity timer expires. If UE is allowed to autonomously enter RRC Idle or Inactive state, then there should be an inactivity timer running at both network and UE side. The value of the inactivity timer is determined by the network and configured for UE. By configuring the inactivity timer via RRC connection setup or resume response (MSG4), the network also confirms that UE autonomous release is allowed. Inactivity timer of zero value indicates an immediate release after the last uplink data transmission. Further, the network may reject UE autonomous release request by not including the inactivity timer value in MSG4.

With UE autonomous release, the RRC Connection Release message is omitted. However, the RRC Connection Release message not only sends UE to Idle/Inactive state, but also carries some information such as resume ID and redirection information. Therefore, with UE autonomous release, such information must be delivered to UE in a different way. An easy way is to use RRC setup/resume response message (MSG4). One particular alternative embodiment of this invention assumes that RRC setup/resume and RRC release messages can be transmitted together, e.g. in the same transport block, or almost together, and because the inactivity timer would be configured for UE release to Idle, UE would not act on the RRC release message until the timer expires.

In step 315, UE 301 transmits an RRC Connection setup or resume Complete message to BS 302 (MSG5), with piggybacked uplink data. Due to deep coverage and the amount of data, the uplink data delivery may not be completed by a single transmission piggybacked in the RRC Connection Setup/Resume Complete message. However as long as UE knows it is sending only one piece of uplink data, UE can tell the network that it wants to enter Idle or Inactive state after the uplink data transmission completes via the RRC connection request (MSG3). Note that the UE indicating autonomous release request via the use of MSG3 is an optional step of this invention. Alternatively, UE may request for autonomous release at MAC layer, as a part of an existing or a new MAC CE. The invention can work also without UE request, e.g. the base station could get information of UE autonomous release request from the core network as well.

UE 301 starts the inactivity timer after last data transmission. Upon expiry of the inactivity timer, UE 301 is autonomously released to Idle or Inactive mode (step 321) without receiving an explicit and independent RRC Connection Release from BS 302. BS 302 also maintains the same inactivity timer and knows that UE 301 is released to Idle or Inactive mode (step 322).

FIG. 4 illustrates a second embodiment of a message flow of RRC connection setup and release supporting UE autonomous release in accordance with one novel aspect. FIG. 4 is similar to FIG. 3. However, in the first embodiment of FIG. 3, it is implicitly assumed that the uplink data transmission takes place after UE receives RRC connection setup message, that is, at MSG5. To further reduce signaling overhead for UEs with small data, it is possible to piggyback the uplink data in RRC connection request message (MSG3). In the second embodiment of FIG. 4, in step 413, UE 401 sends both piggybacked uplink data with DPR and autonomous release request in MSG3. In step 414, BS 402 responds with RRC setup message carrying inactivity timer and other necessary information for UE autonomous release (MSG4). The RRC setup message is seen as a network response for the UE autonomous release, and UE 401 and BS 402 perform the inactivity timer operation accordingly. Upon expiry of the inactivity timer, UE 401 is autonomously released to Idle or Inactive mode (step 421) without receiving the RRC Connection Release from BS 402. BS 402 also maintains the same inactivity timer and knows that UE 401 is released to Idle or Inactive mode (step 422).

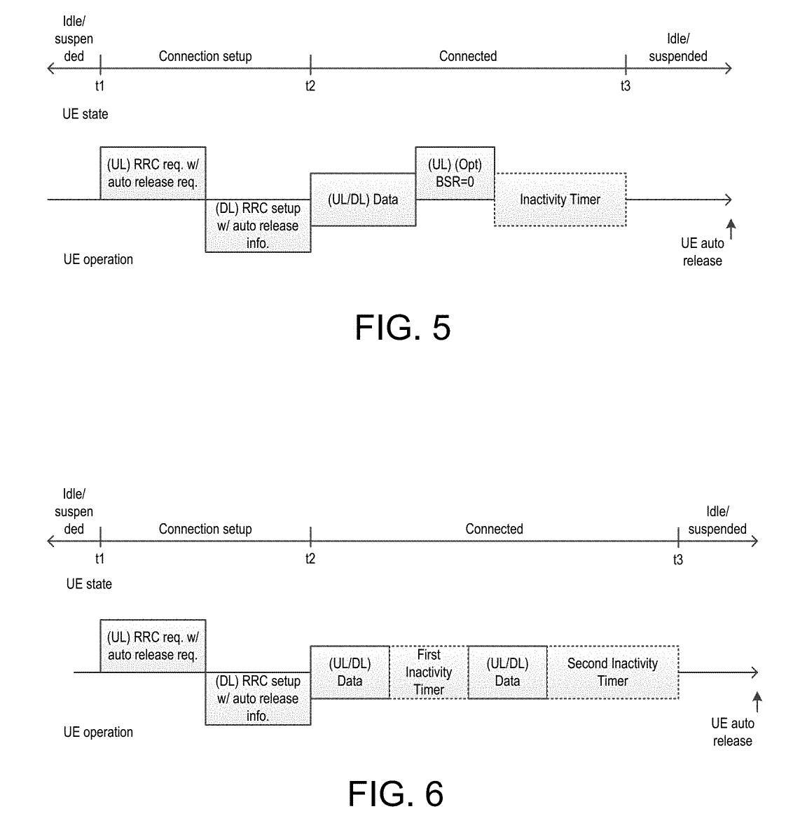

FIG. 5 illustrates a first embodiment of inactivity timer in DRX operation with UE auto release in accordance with one novel aspect. Before time t1, UE is in RRC Idle state. From time t1 to t2, UE starts connection setup by sending RRC connection request with autonomous release request to the network, and in response receives RRC setup with autonomous release information including an inactivity timer value. From time t2 to t3, UE enters RRC Connected state. UE transmits uplink data or receives downlink data. UE starts the inactivity timer after the last data transmission, and the timer value is configured by the network. Specifically, the starting point of the inactivity timer is as follows: 1) upon complete transmission of requested amount of data, for uplink transmission that does not expect network response; 2) upon complete reception of corresponding network response, for uplink transmission that expects network response; and 3) upon RAI (BSR=0) is sent. UE can send Release Assistance Indication (RAI) to tell the network UE has no more data to send so UE can be released. RAI is implemented as Buffer Status Report BSR=0. The last data transmission is indicated by the UE to the network, e.g., UE successfully sent a given amount of data as requested in DPR or BSR, or UE sends BSR=0 indicating it has no data transmission in the near future. At time t3, upon inactivity timer expiry, UE goes to RRC Idle or Inactive state autonomously. The network maintains the same timer and knows UE goes to RRC Idle or Inactivity state. In one embodiment, there are two alternative start values for the inactivity timer, depending on whether RAI (BSR=0) is indicated to the network. In case RAI is indicated, a shorter timer value is chosen (note that a shorter value may be zero), and in case RAI is not indicated, a longer timer value is chosen by the UE.

In prior art, there is a possibility for timer triggered release to RRC Idle. For abnormal conditions, a NAS signaling procedure is always started to recover the connection at timer expiry. However, for the autonomous RRC connection release, the NAS signaling connection recovery shall not be triggered, and the behavior is configured by a new information element. As this is a normal behavior for UE autonomous release, it can be used with benefits also for transition to RRC Inactive state, and/or RRC Light-Connected state.

FIG. 6 illustrates a second embodiment of inactivity timer in DRX operation with UE auto release in accordance with one novel aspect. The embodiment of FIG. 6 is similar to FIG. 5. However, in the embodiment of FIG. 6, a first inactivity timer is stopped due to data arrival (e.g., network response). If any downlink or uplink data transmission takes place when inactivity timer is running, the UE-side inactivity timer is reset and stopped. The UE may then send RAI and start autonomous release again, or rely on network release. In the example of FIG. 6, UE performs autonomous release after a second inactivity timer expires.

The network side also keeps an inactivity timer for each UE so as to maintain the knowledge of UE state. The inactivity timer operation at the network side comprises the following steps: 1) The network starts the inactivity timer for UE autonomous release after last data transmission; 2) Upon inactivity timer expiry, the network assumes UE is in Idle/Inactive state; 3) If any downlink or uplink data transmission takes place when inactivity timer is running, the network-side inactivity timer for autonomous release is reset and stopped; 4) if RAI is received, the inactivity timer for UE autonomous release is restarted. The starting point of the inactivity timer may be determined in the following ways: 1) Upon successfully receiving an amount of data requested by UE, for UL transmission that does not expect network response; 2) Upon complete reception of corresponding network response, for UL transmission that expects network response; and 3) Upon receiving RAI (BSR=0).

In one embodiment, the network may still apply a regular inactivity timer for each data transmission. The values of the regular inactivity timer and the auto-release inactivity timer can be configured separately. Further, the value of the network-side inactivity timer is adjusted for propagation delay. If the timer is started due to the completion of reception in downlink, the network-side inactivity timer is subtracted by the propagation delay so that the expiry point aligns with that of UE-side. If the timer is started due to the completion of transmission in uplink, the network-side inactivity timer is extended by the propagation delay so that the expiry point aligns with that of UE-side.

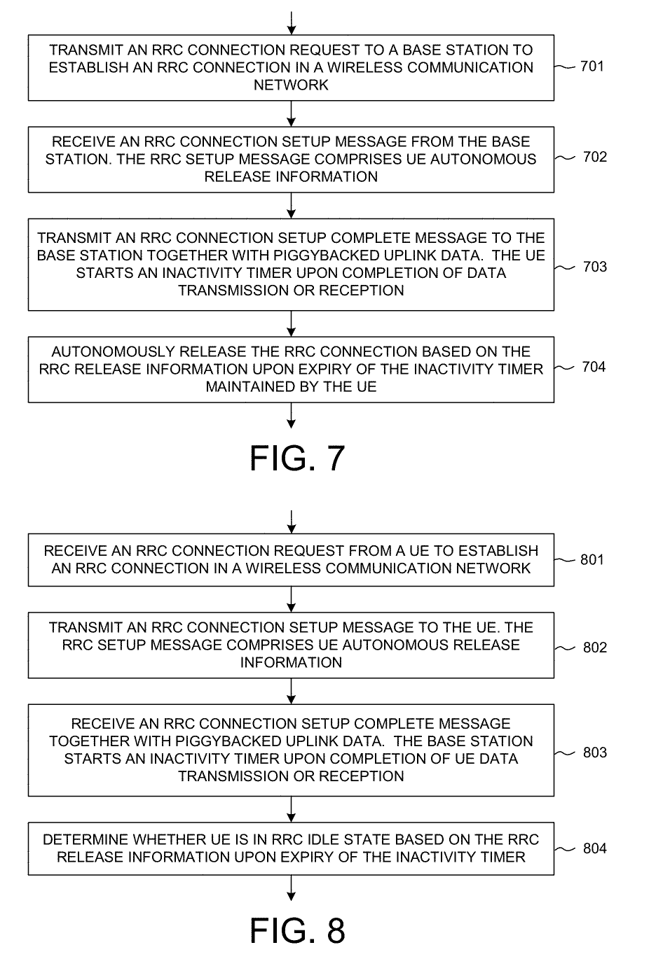

FIG. 7 is a flow chart of a method of UE autonomous release from UE perspective in a wireless communication network in accordance with one novel aspect. In step 701, a UE transmits a radio resource control (RRC) connection request message to a base station to establish an RRC connection in a wireless communication network. In step 702, the UE receives an RRC connection setup message from the base station, wherein the RRC setup message comprises UE autonomous release information. In step 703, the UE transmits an RRC connection setup complete message to the base station together with piggybacked uplink data. The UE starts an inactivity timer upon completion of data transmission/reception. In step 704, the UE autonomously releases the RRC connection based on the RRC release information upon expiry of the inactivity timer maintained by the UE.

FIG. 8 is a flow chart of a method of UE autonomous release from network perspective in a wireless communication network in accordance with one novel aspect. In step 801, a base station receiving a radio resource control (RRC) connection request message from a user equipment (UE) to establish an RRC connection in a wireless communication network. In step 802, the BS transmits an RRC connection setup message, and the RRC setup message comprises UE autonomous release information upon obtaining a UE autonomous release request. In step 803, the BS receives an RRC connection setup complete message together with piggybacked uplink data. The BS starts an inactivity timer for UE autonomous release upon completion of UE data transmission/reception. Finally, in step 804, the BS determines whether the UE is in RRC Idle state based on the RRC release information upon expiry of the inactivity timer.

Although the present invention is described above in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
transmitting a radio resource control (RRC) connection request message to a base station by a user equipment (UE) to establish an RRC connection in a wireless communication network;
receiving an RRC connection setup message from the base station, wherein the RRC setup message comprises UE autonomous release information;
transmitting an RRC connection setup complete message to the base station together with piggybacked uplink data, wherein the UE starts an inactivity timer upon completion of data transmission/reception; and
autonomously releasing the RRC connection based on the RRC release information upon expiry of the inactivity timer maintained by the UE.

2. The method of claim 1, wherein the RRC setup request comprises a UE autonomous release request and a data volume and power headroom report (DPR).

3. The method of claim 1, wherein the UE autonomous release information comprises a value of the inactivity timer.

4. The method of claim 1, wherein the UE autonomous release information comprises a connection resume ID and redirection information.

5. The method of claim 1, wherein the UE autonomously releases the RRC connection without receiving an explicit RRC release message from the base station.

6. The method of claim 1, wherein the UE starts the inactivity timer upon completion of the uplink data transmission, upon completion of a network response reception, or upon sending an indication of Buffer Status Report (BSR)=0.

7. The method of claim 1, wherein the UE applies a first inactivity timer value when a Buffer Status Report (BSR)=0 indication is sent, and wherein the UE applies a second inactivity timer value when the BSR=0 indication is not sent.

8. The method of claim 1, wherein the UE sends the uplink data piggybacked to the RRC connection request message that further includes a UE autonomous release request.

9. A User Equipment (UE), comprising:
a radio frequency (RF) transmitter that transmits a radio resource control (RRC) connection request message to a base station to establish an RRC connection in a wireless communication network;
an RF receiver that receives an RRC connection setup message from the base station, wherein the RRC setup message comprises UE autonomous release information;
an inactivity timer that is started upon completion of data transmission/reception, wherein the UE transmits an RRC connection setup complete message to the base station together with piggybacked uplink data; and
a connection handling circuit that autonomously releases the RRC connection based on the RRC release information upon expiry of the inactivity timer maintained by the UE.

10. The UE of claim 9, wherein the RRC setup request comprises a UE autonomous release request and a data volume and power headroom report (DPR).

11. The UE of claim 9, wherein the UE autonomous release information comprises a value of the inactivity timer.

12. The UE of claim 9, wherein the UE autonomous release information comprises a connection resume ID and redirection information.

13. The UE of claim 9, wherein the UE autonomously releases the RRC connection without receiving an explicit RRC release message from the base station.

14. The UE of claim 9, wherein the UE starts the inactivity timer upon completion of the uplink data transmission, upon completion of a network response reception, or upon sending an indication of Buffer Status Report (BSR)=0.

15. The UE of claim 9, wherein the UE applies a first inactivity timer value when a Buffer Status Report (BSR)=0 indication is sent, and wherein the UE applies a second inactivity timer value when the BSR=0 indication is not sent.

16. The UE of claim 9, wherein the UE sends the uplink data piggybacked to the RRC connection request message that further includes a UE autonomous release request.

17. A method, comprising:
receiving a radio resource control (RRC) connection request message from a user equipment (UE) by a base station to establish an RRC connection in a wireless communication network;
transmitting an RRC connection setup message from the base station, wherein the RRC setup message comprises UE autonomous release information upon obtaining a UE autonomous release request;
receiving an RRC connection setup complete message together with piggybacked uplink data, wherein the base station starts an inactivity timer for UE autonomous release upon completion of UE data transmission/reception; and
determining whether the UE is in RRC Idle state based on the RRC release information upon expiry of the inactivity timer.

18. The method of claim 17, wherein the base station obtains the UE autonomous release request from a core network or from the RRC connection request message.

19. The method of claim 17, wherein the base station also maintains a regular inactivity timer in addition to the inactivity timer for UE autonomous release.

20. The method of claim 17, wherein the base station adjusts the inactivity timer for propagation delay between the base station and the UE.
